(19) United States
(12) Patent Application Publication
(10) Pub. No.: US 2026/0307957 A1
(43) Pub. Date: Oct. 8, 2026

(54) PROTECTED SCREW DRIVE SCISSOR JACK

(71) Applicant: Pro Eagle LLC, Torrance, CA (US)

(72) Inventor: Benson Su, Torrance, CA (US)

(21) Appl. No.: 19/169,451

(22) Filed: Apr. 3, 2025

(51) Int. Cl. B66F 3/12

(52) U.S. Cl. CPC B66F 3/12

(57) ABSTRACT

An improved protected scissor jack comprises a screw coupled with a screw actuator, that is coupled with a first upper arm and a first lower arm. It also includes a screw tensioner coupled with a screw tensioner end piece, which is coupled with a second upper arm and a second lower arm. The screw is housed within a screw sheath and is coupled to the screw tensioner via threading. The first upper arm and the second upper arm are coupled to a lifting component by pivot joints and interact with each other through synchronizing gears. Similarly, the first lower arm and the second lower arm are coupled to a base by pivot joints and interact with each other through synchronizing gears.

### FIELD OF THE INVENTION

The field of the invention is scissor jacks.

### BACKGROUND

The background description includes information that may be useful in understanding the present invention. It is not an admission that any of the information provided in this application is prior art or relevant to the presently claimed invention, or that any publication specifically or implicitly referenced is prior art.

Off-roading enthusiasts frequently encounter rugged terrains that can cause significant wear and tear on vehicle components. One crucial piece of equipment for such activities is the scissor jack, which is essential for lifting vehicles during tire changes or repairs. But traditional scissor jacks often suffer from exposure to mud, dirt, and other debris, which can damage the screw mechanism and compromise the jack's functionality.

This exposure to harsh environmental conditions can lead to a decrease in the efficiency and lifespan of the scissor jack. Mud and dirt can accumulate on the screw mechanism, causing it to jam or operate less smoothly. In extreme cases, the debris can cause permanent damage that renders the jack unusable. Therefore, there is a pressing need for a solution that can mitigate these issues and provide a more reliable tool for off-roading enthusiasts.

This persistent issue highlights the need for an improved scissor jack design that incorporates a protective feature to shield the screw mechanism from environmental contaminants. Protecting the screw mechanism will enhance the durability and reliability of the scissor jack, ensuring it remains operational even in the harshest off-road conditions. Such a design would ultimately provide off-roading enthusiasts with a dependable tool that can withstand the rigors of their adventurous activities.

### SUMMARY OF THE INVENTION

The inventive subject matter described in this patent application is directed to scissor jacks with protected screw components. In one aspect of the inventive subject matter, a protected scissor jack comprises: a screw having a screw actuator, where the screw actuator is rotatably coupled with a screw collar; where the screw collar is coupled with a first upper arm and with a first lower arm by an actuator-side pivot joint; a screw tensioner having a screw tensioner end piece, where the screw tensioner end piece is coupled with a second upper arm and with a second lower arm by an actuator-side pivot joint; a screw sheath coupled with the screw collar and having the screw disposed therein; where the screw couples with the screw tensioner via threading; and a sheath collar coupled with an end of the screw sheath and comprising a wiper ring, where the wiper ring contacts an outer surface of the screw tensioner.

In some embodiments, the first upper arm and the second upper arm interact with each other by synchronizing gears. The first lower arm and the second lower arm can also interact with each other by synchronizing gears.

In another aspect of the inventive subject matter, a protected scissor jack comprises: a screw; a screw tensioner; a screw sheath, where the screw sheath is hollow and the screw is disposed therein; and where the screw couples with the screw tensioner via threading. In some embodiments the scissor jack also includes: a screw collar that is coupled with a screw actuator, wherein the screw actuator is coupled with the screw; and a screw tensioner end piece that is coupled with the screw tensioner.

Some embodiments also have a first upper arm, a second upper arm, a first lower arm, and a second lower arm, where the first upper arm and the first lower arm are coupled by an actuator-side pivot joint and where the second upper arm and the second lower arm are coupled by a tensioner-side pivot joint. In some embodiments, the first upper arm and the second upper arm both couple with a lifting component by pivot joints. In some embodiments, the first upper arm and the second upper arm interact with each other by synchronizing gears. In some embodiments, the first lower arm and the second lower arm both couple with a base by pivot joints, and the first lower arm and the second lower arm can interact with each other by synchronizing gears.

In another aspect of the inventive subject matter, a protected scissor jack comprises: a screw having a screw actuator, where the screw actuator is coupled with a first upper arm and with a first lower arm; a screw tensioner having a screw tensioner end piece, where the screw tensioner end piece is coupled with a second upper arm and with a second lower arm; a screw sheath having the screw disposed therein; and where the screw couples with the screw tensioner via threading.

In some embodiments, the first upper arm and the second upper arm both couple with a lifting component by pivot joints. The first upper arm and the second upper arm can also interact with each other by synchronizing gears. The first lower arm and the second lower arm both couple with a base by pivot joints, and the first lower arm and the second lower arm can also interact with each other by synchronizing gears.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 shows a scissor jack of the inventive subject matter.

FIG. 2 shows an alternative view of the scissor jack.

FIG. 3 shows how upper arms interact with one another.

FIG. 4 shows how lower arms interact with one another.

FIG. 5 shows a cutaway view of where the screw meets the screw tensioner

FIG. 6 shows the actuator side of the scissor jack.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

Also, as used in this application, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Embodiments of the inventive subject matter are directed to a scissor jack equipped with a sheath designed to protect its screw drive mechanism. This innovative sheath not only safeguards the screw drive from dust, dirt, and other contaminants but also enhances the overall durability and longevity of the scissor jack. Scissor jacks of the inventive subject matter especially useful in off-roading situations, where dirt, mud, and other contaminants are commonly encountered, and also where jack failure on a backcountry trail is an unacceptable outcome. Furthermore, the sheath ensures smoother operation and reduces maintenance needs, thereby reducing the amount of torque required to actuate the jack, making it an essential feature for both casual users and professionals in a variety of different situations, including offroad use.

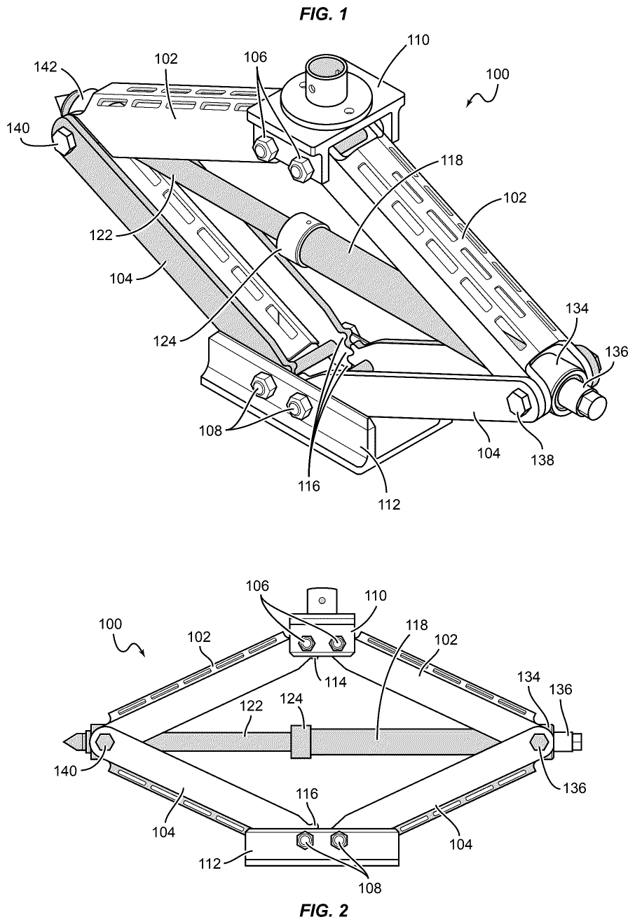

FIGS. 1 and 2 show two views of a scissor jack of the inventive subject matter. Scissor jack 100 features upper arms 102 and lower arms 104. Upper arms 102 are coupled together via upper arm pin joints 106, lower arms 104 are coupled via lower arm pin joints 108. There are two upper arm pin joints 106 and two lower arm pin joints 108. Upper arm pin joints 108 are disposed on lifting component 110, and lower arm pin joints are disposed on base 112. Lifting component 110 features both upper arm pin joints 108, which are offset from one another such that each upper arm 102 couples with lifting component 110 at a different location. But without some way for the movements of both upper arm 102 being synchronized in some way, lifting component 110 would be unstable and subject to unwanted rotation.

Upper and lower arms are formed with U-shaped cross sections have bracketed ends. The U-shape is strong and unlikely to twist, bend, or buckle, and one bracketed end on each of an upper arm and a lower arm are configured such that the upper arm's bracketed end can nest within the lower arm's bracketed end. Once aligned, pivot joints can be coupled with through holes on the bracketed ends as shown in the figures. On a side of each arm opposite the bracketed end is another bracketed end having synchronizing gears. Synchronizing gears on an upper arm, for example, interact with the synchronizing gears of another upper arm, and the same is true for each lower arm.

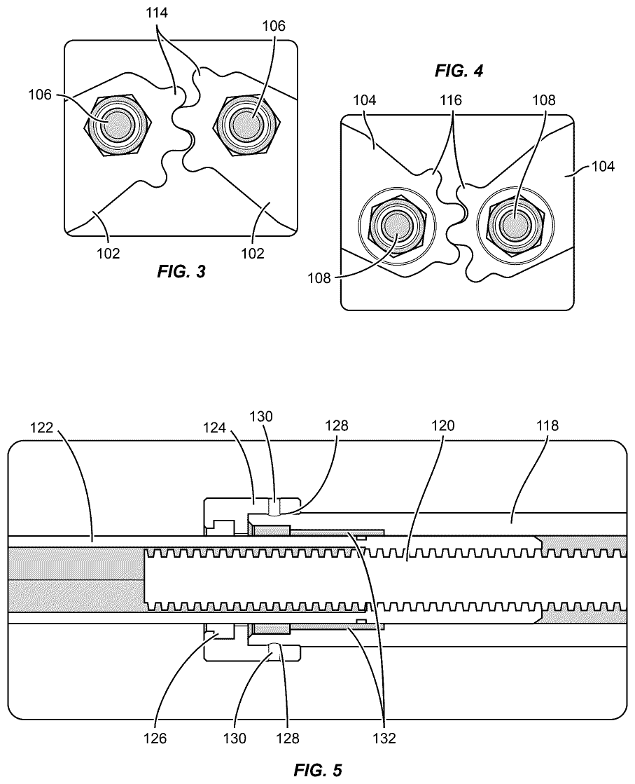

Thus, FIG. 3 shows how upper arms 102 interact with one another. Upper arms 102 are shown without lifting component 110 obstructing the view, showing upper arm synchronizing gears 114. Upper arm synchronizing gears 114 are configured such that they interact with each other as scissor jack 100 is raised or lowered. Because upper arms 102 are coupled with lifting component 110 by pivot joints, lifting component 110 would be free to rotate off level without upper arm synchronizing gears 114, which force upper arms 102 to raise and lower in sync with each other.

Similarly, FIG. 4 shows how lower arms 104 interact with one another. Lower arms 104 are shown without base 112 obstructing the view, showing lower arm synchronizing gears 116. Lower arm synchronizing gears 116 are configured such that they interact with each other as scissor jack 100 is raised or lowered. Because lower arms 104 are coupled with base 112 by pivot joints, lower arms 104 would be free to rotate relative to base 112, which could create instability in scissor jack 100. Lower arm synchronizing gears 116 thus provide stability by forcing lower arms 104 to rotate in tandem as scissor jack 100 is raised or lowered.

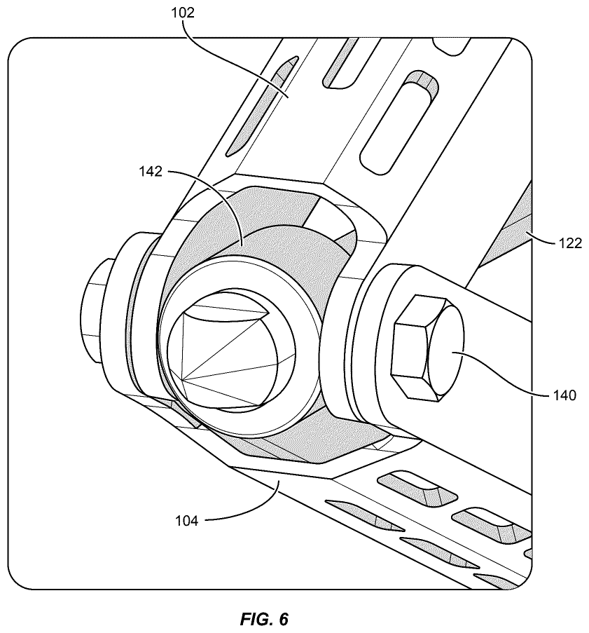

To raise or lower scissor jack 100, a rotatable screw that mates with a fixed screw tensioner is rotated. In a typical scissor jack, the screw component is exposed, but in embodiments of the inventive subject matter the screw is covered by screw sheath 118. Screw sheath 118 is a hollow component that prevents things like dust, mud, dirt, sand, and other detritus from impacting jack performance by interfering with screw rotation. As shown in FIG. 5, screw 120 couples with screw tensioner 122. An end of screw tensioner 122 (on the right side as drawn) features female threading, which is sized and dimensioned to interact with mail threading on screw 120.

At an end screw sheath 118 is sheath collar 124. Sheath collar 124 features wiper ring 126, which creates a seal between sheath collar 124 and screw tensioner 122. wiper ring 126 is intended to prevent dirt, dust, or the like from getting beneath screw sheath 118, which would negatively impact performance. A wiper ring is a component designed to prevent dirt, dust, and other contaminants from entering and affecting the performance of mechanical systems. They can be made from a variety of materials, including rubbers, plastics, and combinations of different materials. Wiper rings can be thought of as specially shaped O-rings. Whereas O-rings typically have circular cross-sections, wiper rings may have different cross-sectional shapes that enhances their functionality. Wiper ring 126 shown in FIG. 5 features an elongated portion that contacts an outer surface of screw tensioner 122, with an extruded notch portion on an exterior side of wiper ring 126 that fits into a complementary groove on an interior side of sheath collar 124.

As scissor jack 100 is actuated and screw sheath 118 moves relative to screw tensioner 122, wiper ring 126 scrapes along the outer surface of screw tensioner 122. Because wiper ring 126 creates a pressure fit between sheath collar 124 and screw tensioner 122 (e.g., it has a smaller inner diameter than the outer diameter of screw tensioner 122), as scissor jack 100 is actuated either up or down, wiper ring 126 slides across screw tensioner 122 and acts as a squeegee that scrapes dirt, dust, and other potentially damaging detritus from screw tensioner 122 that could otherwise get onto screw 120 and cause damage or negatively impact performance.

Sheath collar 124 couples with screw sheath 118 by mating groove 128. Sheath collar 124 features a mating protrusion 130 that is annular and disposed within sheath collar 124 such that it fits into mating groove 128 that is disposed on an exterior surface of screw sheath 118. In some embodiments each mating protrusion is a set screw that fastens sheath collar 124 to screw sheath 118. Sheath collar 124 is thus mated to screw sheath 118 such that the two components move as one. Screw sheath 118 also includes a pressure fit collar 132 disposed on an interior surface of screw sheath 118.

Pressure fit collar 132 serves several purposes. Like wiper ring 126, pressure fit collar 132 prevents dust and other detritus from getting into the interior of screw sheath 118 by providing a second line of defense. Pressure fit collar 132 also facilitates smooth linear movements of screw sheath 118 as it moves relative to screw tensioner 122. To ensure smooth movements, pressure fit collar 132 can be made from a material that is designed to for low coefficients of friction (e.g., a hard plastic) between itself and screw sheath 118. By contacting both screw sheath 118 and screw tensioner 122, pressure fit collar 132 also prevents unwanted off-axis movements of those components relative to one another. Thus, pressure fit collar 132 ensures screw sheath 118 remains coaxial with screw tensioner 122 during use.

Pressure fit collar 132 fits within a groove that exists on an interior surface of screw sheath 118, where the groove has a larger inner diameter than the rest of screw sheath 118. Pressure fit collar 132 can be connected to screw sheath 118 by, e.g., an adhesive. In some embodiments, it can be connected to screw sheath collar by snapping into place.

Turning back to FIG. 1, an actuation subsystem having a screw collar 134, a screw actuator 136, and an actuator-side pivot joint 138 is disposed on a side of scissor jack 100. Screw actuator 136 can be caused to rotate by, e.g., an accompanying actuation tool (e.g., a manual crank), by power tool (e.g., electric or pneumatic), or the like. Actuator-side pivot joint 138 couples an upper arm 102 with a lower arm 104. Upper arm 102 couples with lower arm 104 such that they form a bracket, and in that bracket space, screw collar 134 is disposed. Screw collar 134 is designed to accommodate screw actuator 136, which couples with screw 120. Thus, by turning screw actuator 136, screw 120 is caused to rotate, and screw 120 interacts with screw tensioner 122 to cause scissor jack 100 to raise or lower, depending on which direction screw actuator 136 is rotated. Screw actuator 136 is mounted within screw collar 134 such that screw actuator 136 can rotate freely relative to screw collar 134, which is otherwise stationary outside of being able to rotate about actuator-side pivot joint 138. Screw actuator 136 can be mounted into screw collar 134 by, e.g., a bearing, or it can alternatively be mounted by a low-friction mechanism or part that is disposed between the two components (e.g., a hard plastic collar).

As shown in FIG. 6, on an opposite side of scissor jack 100 from actuator-side pivot joint 138 is tensioner-side pivot joint 140. Tensioner-side pivot joint 140 couples an upper arm 102 with a lower arm 104, which together form a bracketed space. Screw tensioner end piece 142 is disposed within that bracketed space. Screw tensioner end piece 142 is coupled with tensioner-side pivot joint 140, and screw tensioner 122 is fixedly coupled with screw tensioner end piece 142. Thus, as screw 120 is rotated, it moves relative to screw tensioner 122, which causes lifting component 110 to raise or lower, depending on which direction screw 120 is rotated. FIGS. 1 and 2 show arrows indicating how screw actuator 136 can rotate, as well as arrows indicating lateral movements of screw sheath 118 relative to screw tensioner 122 that can occur during use.

Thus, specific scissor jacks that are designed to have been disclosed. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A protected scissor jack comprising:
a screw having a screw actuator, wherein the screw actuator is rotatably coupled with a screw collar;
wherein the screw collar is coupled with a first upper arm and with a first lower arm by an actuator-side pivot joint;
a screw tensioner having a screw tensioner end piece, wherein the screw tensioner end piece is coupled with a second upper arm and with a second lower arm by an actuator-side pivot joint;
a screw sheath coupled with the screw collar and having the screw disposed therein;
wherein the screw couples with the screw tensioner via threading; and
a sheath collar coupled with an end of the screw sheath and comprising a wiper ring, wherein the wiper ring contacts an outer surface of the screw tensioner.

2. The protected scissor jack of claim 1, wherein the first upper arm and the second upper arm interact with each other by synchronizing gears.

3. The protected scissor jack of claim 1, wherein the first lower arm and the second lower arm interact with each other by synchronizing gears.

4. A protected scissor jack comprising:
a screw;
a screw tensioner;
a screw sheath;
wherein the screw sheath is hollow and the screw is disposed therein; and
wherein the screw couples with the screw tensioner via threading.

5. The protected scissor jack of claim 4, further comprising:
a screw collar that is coupled with a screw actuator, wherein the screw actuator is coupled with the screw; and
a screw tensioner end piece that is coupled with the screw tensioner.

6. The protected scissor jack of claim 5, further comprising a first upper arm, a second upper arm, a first lower arm, and a second lower arm, wherein the first upper arm and the first lower arm are coupled by an actuator-side pivot joint and wherein the second upper arm and the second lower arm are coupled by a tensioner-side pivot joint.

7. The protected scissor jack of claim 6, further comprising the first upper arm and the second upper arm that both couple with a lifting component by pivot joints.

8. The protected scissor jack of claim 7, wherein the first upper arm and the second upper arm interact with each other by synchronizing gears.

9. The protected scissor jack of claim 6, wherein the first lower arm and the second lower arm both couple with a base by pivot joints.

10. The protected scissor jack of claim 9, wherein the first lower arm and the second lower arm interact with each other by synchronizing gears.

11. A protected scissor jack comprising:
a screw having a screw actuator, wherein the screw actuator is coupled with a first upper arm and with a first lower arm;
a screw tensioner having a screw tensioner end piece, wherein the screw tensioner end piece is coupled with a second upper arm and with a second lower arm;
a screw sheath having the screw disposed therein; and
wherein the screw couples with the screw tensioner via threading.

12. The protected scissor jack of claim 11, wherein the first upper arm and the second upper arm both couple with a lifting component by pivot joints.

13. The protected scissor jack of claim 12, wherein the first upper arm and the second upper arm interact with each other by synchronizing gears.

14. The protected scissor jack of claim 11, wherein the first lower arm and the second lower arm both couple with a base by pivot joints.

15. The protected scissor jack of claim 14, wherein the first lower arm and the second lower arm interact with each other by synchronizing gears.
